(19) United States
(12) Patent Application Publication
(10) Pub. No.: US 2026/0178071 A1
(43) Pub. Date: Jun. 25, 2026

(54) INPUT HOLD FOR DUAL POWER RAIL MEMORIES

(71) Applicant: QUALCOMM Incorporated, San Diego, CA (US)

(72) Inventors: Sonia GHOSH, San Diego, CA (US); Xiao CHEN, San Diego, CA (US)

(21) Appl. No.: 18/988,781

(22) Filed: Dec. 19, 2024

(51) Int. Cl. G06F 1/04

(52) U.S. Cl. CPC G06F 1/04

(57) ABSTRACT

A data capture circuit has a first latch provided in a first voltage domain and a gating circuit also provided in the first voltage domain. The gating circuit may be configured to couple an input signal to an input of the first latch when a first clock signal is in a first signaling state and a second clock signal is in a second signaling state. The gating circuit may be disabled when the first clock signal is in a third signaling state or the second clock signal is in a fourth signaling state. The first clock signal may be configured to control timing of circuits in the first voltage domain and the second clock signal may be configured to control timing of circuits in a second voltage domain.

### TECHNICAL FIELD

The present disclosure generally relates to interfaces between voltage domains and, more particularly, to data capture circuits that can accommodate different timing specifications defined for multiple voltage domains.

### BACKGROUND

Electronic device technologies have seen explosive growth over the past several years. For example, growth of cellular and wireless communication technologies has been fueled by better communications, hardware, larger networks, and more reliable protocols. Wireless service providers are now able to offer their customers an ever-expanding array of features and services, and provide users with unprecedented levels of access to information, resources, and communications. To keep pace with these service enhancements, mobile electronic devices have become more powerful and complex than ever.

Increasing demand for greater functionality in apparatus including cellular telephones, smart phones, global positioning satellite navigators, media players and the like requires the development of semiconductor integrated circuit (IC) devices that have higher circuit density and which switch at higher frequencies to provide increased functionality and speed of operation with low power. Advances in speed and size may be accomplished through the use of ICs fabricated with decreased process geometries and/or lowered operating voltages. ICs may include processors with core logic circuits and/or memory circuits that operate in voltage domains at a low core voltage. A processor may be coupled to an interface and/or input and output (I/O) circuits and/or drivers that function in different voltage domains.

Device manufacturing technology continues to improve, and operational characteristics of communication interfaces may be affected by improvements in process technology. Accordingly, many electronic devices and appliances include circuits that shift between logic levels defined for different circuits that are associated with different voltage domains, or that otherwise translate digital logic signals from a low voltage range to a higher voltage range. Different timing specifications may apply to different voltage domains. Accordingly, there is an ongoing need for improved data transmission and capture in devices that provide or support multiple voltage domains.

### SUMMARY

Certain aspects of the disclosure relate to systems, apparatus, methods and techniques that can be used in integrated circuit (IC) devices that include multiple voltage domains and circuits that communicate across an interface between two different voltage domains. In one aspect, a data capture circuit may be configured to reliably sample or capture data in one voltage domain from a signal received from a another voltage domain through a level-shifting circuit. The data capture circuit may be configured to accommodate differences between timing specifications that govern transmission signals in the voltage domains.

In various aspects of the disclosure, a data capture circuit has a first latch and a gating circuit that are provided in a first voltage domain. The gating circuit may be configured to couple an input signal to an input of the first latch when a first clock signal is in a first signaling state and a second clock signal is in a second signaling state. The gating circuit may be disabled when the first clock signal is in a third signaling state or the second clock signal is in a fourth signaling state. The first clock signal may be configured to control timing of circuits in the first voltage domain and the second clock signal may be configured to control timing of circuits in the second voltage domain.

In various aspects of the disclosure, an apparatus includes means for gating an input signal in a first voltage domain, the input signal being a level-shifted version of a control or data signal generated by a circuit in a second voltage domain, and means for capturing signaling state of the input signal in the first voltage domain, including a first latch that is controlled by a first clock signal and a second clock signal. The means for gating the input signal may be configured to couple the input signal to an input of the first latch when the first clock signal is in a first signaling state and the second clock signal is in a second signaling state. The first clock signal may be configured or used to control timing of circuits in the first voltage domain and the second clock signal may be configured or used to control timing of circuits in the second voltage domain.

In various aspects of the disclosure, a method for transferring data between voltage domains includes receiving an input signal in a first voltage domain, coupling the input signal to an input of a first latch in the first voltage domain when a first clock signal is in a first signaling state and a second clock signal is in a second signaling state, and blocking the input signal from the input of the first latch when the first clock signal is in a third signaling state or the second clock signal is in a fourth signaling state. The input signal may be a level-shifted version of a control or data signal generated by a circuit in a second voltage domain. The first clock signal may be configured or used to control timing of circuits in the first voltage domain and the second clock signal may be configured or used to control timing of circuits in the second voltage domain.

In certain aspects, the first clock signal is a level-shifted, in-phase version of the second clock signal. The input signal may be representative of a control or data signal generated by a circuit in the second voltage domain. The input signal may be a level-shifted version of the control or data signal generated to transmitted by the second voltage domain.

In certain aspects, the first latch includes a feedback circuit having an input coupled to an output of the first latch and configured to drive the input of the first latch when the gating circuit is disabled. In some implementations, the feedback circuit is configured to drive the input of the first latch when the first clock signal is in the third signaling state or the second clock signal is in the fourth signaling state.

In certain aspects, the gating circuit is a gating inverter that is controlled by a differential version of the first clock signal and a differential version of the second clock signal.

In certain aspects, a second latch provided in the first voltage domain has an input coupled to an output of the first latch and the operation of the second latch is controlled by the first clock signal.

### BRIEF DESCRIPTION OF THE DRAWINGS

FIG. 1 illustrates an example of a system-on-a-chip (SOC) that may be adapted in accordance with certain aspects of the present disclosure.

FIG. 2 illustrates certain aspects of timing defined for sequential logic circuits, including circuits in a multi-rail memory device.

FIG. 3 illustrates an example of an interface between voltage domains in a conventional memory device.

FIG. 4 illustrates a first example of an interface configured in accordance with certain aspects of this disclosure.

FIG. 5 illustrates a second example of an interface configured in accordance with certain aspects of this disclosure.

FIG. 6 is a flow diagram illustrating an example of a method for transferring data between voltage domains in accordance with certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

With reference now to the Figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

The terms “computing device” and “mobile device” are used interchangeably herein to refer to any one or all of servers, personal computers, smartphones, cellular telephones, tablet computers, laptop computers, notebooks, ultrabooks, palm-top computers, personal data assistants (PDAs), wireless electronic mail receivers, multimedia Internet-enabled cellular telephones, Global Positioning System (GPS) receivers, wireless gaming controllers, and similar personal electronic devices which include a programmable processor. While the various aspects are particularly useful in mobile devices (e.g., smartphones, laptop computers, etc.), which have limited resources (e.g., processing power, battery, size, etc.), various aspects are generally useful in any computing device that may benefit from improved performance and design flexibility.

The term “multicore processor” is used herein to refer to a single integrated circuit (IC) chip or chip package that contains two or more independent processing units or cores (e.g., CPU cores, etc.) configured to read and execute program instructions. The term “multiprocessor” is used herein to refer to a system or device that includes two or more processing units configured to read and execute program instructions.

The term “system on chip” (SoC) is used herein to refer to a single integrated circuit (IC) chip that contains multiple resources and/or processors integrated on a single substrate. A single SoC may contain circuitry for digital, analog, mixed-signal, and radio-frequency functions. A single SoC may also include any number of general purpose and/or specialized processors (digital signal processors (DSPs), modem processors, video processors, etc.), memory blocks (e.g., read only memory (ROM), random access memory (RAM), flash, etc.), and resources (e.g., timers, voltage regulators, oscillators, etc.), any or all of which may be included in one or more cores.

Process technology employed to manufacture semiconductor devices, including IC devices is continually improving. Process technology includes the manufacturing methods used to make IC devices and defines transistor size, operating voltages and switching speeds. Features that are constituent elements of circuits in an IC device may be referred as technology nodes and/or process nodes. The terms technology node, process node, process technology may be used to characterize a specific semiconductor manufacturing process and corresponding design rules. Faster and more power-efficient technology nodes are being continuously developed through the use of smaller feature size to produce smaller transistors that enable the manufacture of higher-density ICs.

Memory technologies described herein may be suitable for storing instructions, programs, control signals, and/or data for use in or by a computer or other digital electronic device. Any references to terminology and/or technical details related to an individual type of memory, interface, standard, or memory technology are for illustrative purposes only, and not intended to limit the scope of the claims to a particular memory system or technology unless specifically recited in the claim language. Mobile computing device architectures have grown in complexity, and now commonly include multiple processor cores, SoCs, co-processors, functional modules including dedicated processors (e.g., communication modem chips, GPS receivers, etc.), complex memory systems, intricate electrical interconnections (e.g., buses and/or fabrics), and numerous other resources that execute complex and power intensive software applications (e.g., video streaming applications, etc.).

In many implementations, an IC device may include and/or distinguish between internal core circuits, peripheral circuits, I/O circuits, memory and other circuits. The internal core circuits may be included in a section of the IC that may be referred to simply as a “core” that performs certain functions including storing data (memory), managing stored data, performing certain logic functions, processing-specific functions, cryptography, image processing and so on. More than one section of an IC may be defined as a core. In many examples, the devices and/or circuits in a core may be configurable to operate at the highest possible operating frequency enabled by the process technology. In many examples, the operating frequency of circuits in a core may be constrained by a power budget and the operating frequency of some core circuits may be configured to obtain fastest operation within the power budget. Lower power consumption in high-speed circuits can be achieved by reducing the operating voltage of the core, and process technologies have been evolving to support ever-lower core operating voltages.

An IC device typically receives power from an external power supply. Examples of external power supplies include batteries, solar cells or solar panels, switching power supplies and other types of power converters. The external power supply may provide power at different voltage levels, where the voltage levels are measured with respect to a ground reference. In one example, the ground reference may be designated to be a zero-volt level. Multiple power rails may be provided to carry current to or from the power supply. Each power rail provides a low resistance path for current flows and each power rail may be implemented using one or more wires, connectors, interconnects, traces on a circuit board or the like. The IC device may be coupled to two or more of the power rails and may extend these power rails internally using low-impedance interconnects or conductive planes with the IC structure. The internal power rails conduct current to the various sections of the IC device at a voltage level defined for the respective power rails.

In some examples, the internal power rails may be referred to as internal power sources or power sources, although the power rails may serve as conduits for external power sources. In some examples, internal power sources may include internal power rails that are driven by power conditioning circuits, power conversion circuits or circuits that step up or step down voltage levels for use within the IC device. In some examples, the internal power rails may be labeled according to usage. In some examples, the ground reference of an IC device or of a section of an IC device may be labeled Voltage-Source-Source (Vₛₛ), and non-zero power rails may be labeled Voltage-Drain-Drain (V_{dd}). In many examples, the IC may provide multiple V_{dd} power rails, labeled V_{dd}1, V_{dd}2, V_{dd}3, . . . V_{dd}X, etc. The ground reference may provide a return path for currents flowing through the IC device.

In some instances, different voltage domains may be identified in an IC device. Each voltage domain may include multiple devices or circuits that receive power at a common voltage level. In one example, a first voltage domain may include devices that are coupled between a Vₛₛ rail and a V_{dd}1 rail, a second voltage domain may include devices that are coupled between the Vₛₛ rail and a V_{dd}2 rail, a third voltage domain may include devices that are coupled between the Vₛₛ rail and a V_{dd}3 rail, and so on. A voltage domain may also be referred to as a power domain. The evolution of process technology and the corresponding evolution of transistor technology has led to decreased gate oxide thickness and lower operating voltages in some types of circuits.

Certain aspects of the disclosure are applicable to serializer/deserializer (SERDES) circuits used to transmit and receive data over a serial communication link. SERDES circuits may be included in certain input/output (I/O) circuits. For example, SERDES circuits may be used in an IC device that provide an interface between core circuits and memory devices. Many mobile devices employ Synchronous Dynamic Random Access Memory (SDRAM), including Low-Power Double Data Rate (DDR) SDRAM, which may be referred to as low-power DDR SDRAM, LPDDR SDRAM or, in some instances, LPDDRx where x describes the technology generation of the LPDDR SDRAM. Later generations of LPDDR SDRAM designed to operate at higher operating frequencies.

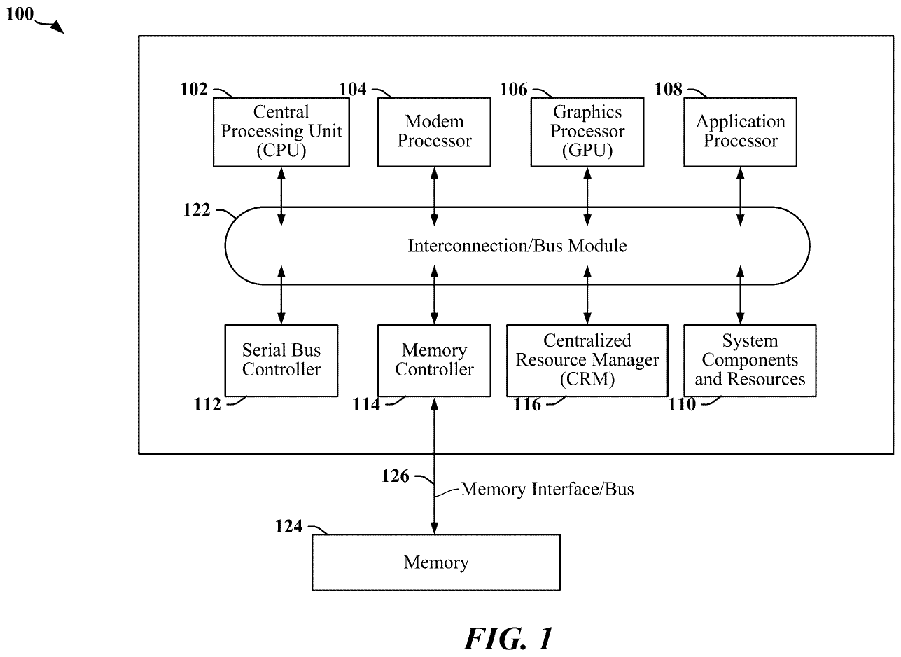

FIG. 1 illustrates an example of components and interconnections in a system-on-chip (SoC) 100, including a memory interface/bus 126, that may be suitable for implementing certain aspects of the present disclosure. The SoC 100 may include a number of heterogeneous processors, such as a central processing unit (CPU) 102, a modem processor 104, a graphics processor 106, and an application processor 108. Each processor 102, 104, 106, 108, may include one or more cores, and each processor/core may perform operations independent of the other processors/cores. The processors 102, 104, 106, 108 may be organized in close proximity to one another (e.g., on a single substrate, die, integrated chip, etc.) so that the processors may operate at a much higher frequency/clock rate than would be possible if the signals were to travel off-chip. The proximity of the cores may also allow for the sharing of on-chip memory and resources (e.g., power rails), as well as for more coordinated cooperation between cores.

The SoC 100 may include system components and resources 110 for managing sensor data, analog-to-digital conversions, and/or wireless data transmissions, and for performing other specialized operations (e.g., decoding high-definition video, video processing, etc.). System components and resources 110 may also include components such as voltage regulators, oscillators, phase-locked loops (PLLs), peripheral bridges, data controllers, system controllers, access ports, timers, and/or other similar components used to support the processors and software clients running on the computing device. The system components and resources 110 may also include circuitry for interfacing with peripheral devices, such as cameras, electronic displays, wireless communication devices, external memory chips, etc.

The SoC 100 may further include a Universal Serial Bus (USB) or other serial bus controller 112, one or more memory controllers 114, and a centralized resource manager (CRM) 116. The SoC 100 may also include an input/output module (not illustrated) for communicating with resources external to the SoC, each of which may be shared by two or more of the internal SoC components.

The processors 102, 104, 106, 108 may be interconnected to the USB controller 112, the memory controller 114, system components and resources 110, CRM 116, and/or other system components via an interconnection/bus module 122, which may include an array of reconfigurable logic gates and/or implement a bus architecture. Communications may also be provided by advanced interconnects, such as high performance networks on chip (NoCs).

The interconnection/bus module 122 may include or provide a bus mastering system configured to grant SoC components (e.g., processors, peripherals, etc.) exclusive control of the bus (e.g., to transfer data in burst mode, block transfer mode, etc.) for a set duration, number of operations, number of bytes, etc. In some cases, the interconnection/bus module 122 may implement an arbitration scheme to prevent multiple master components from attempting to drive the bus simultaneously. The memory controller 114 may be a specialized hardware module configured to manage the flow of data to and from a memory 124 via the memory interface/bus 126.

The memory controller 114 may comprise one or more processors configured to perform read and write operations with the memory 124. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In certain aspects, the memory 124 may be part of the SoC 100.

The memory 124 may be implemented using memory devices that can be configured to operate in accordance with specifications defining the operational characteristics of multiple types of LPDDRi SDRAM. In one example, a memory device may be operated in LPDDR2 SDRAM and LPDDR4X SDRAM modes of operation, which may be referred to herein as the “LP2” and “LP4X” modes, respectively. The memory device includes double data rate input/output circuits (DDRIO) that enable the memory device to communicate with corresponding I/O circuits in the SoC 100 or another device coupled to the memory device. The DDRIO may be configurable for multi-mode operation. In some instances, a transmitter in the DDRIO of a memory device that supports LP2 and LP4X modes of operation may include multiple circuits that perform the same function at different voltage levels.

Certain aspects of this disclosure relate to memory devices and associated circuits that operate within a core voltage domain. For the purposes of this disclosure, the core voltage domain for memory may be supplied by a power rail referred to as the MX power rail (VDD_{MX}), with at least some associated circuits being provided in a periphery voltage domain that is supplied by a power rail referred to as the CX power rail (VDD_{CX}), when dual-power rail specifications or designs are supported. In many implementations, input signals are level shifted from voltage levels supported by the periphery voltage domain to the core voltage domain. Certain timing specifications may be affected by level shifting, whereby a signal shifting circuit receives a signal that switches between signaling states within a first voltage range and outputs a phase-aligned signal that switches between corresponding signaling states within a second voltage range. In one example, a level shifting circuit includes a stack of low-voltage transistors coupled between power rails that have a voltage difference greater than the nominal maximum voltage level defined for the low-voltage transistors. The gate inputs of the stack of low-voltage transistors may be configured to ensure that voltage drops are shared by all of the transistors in the stack of low-voltage transistors. In some instances, a combination of low-voltage transistors and transistors rated for higher voltage levels may be stacked.

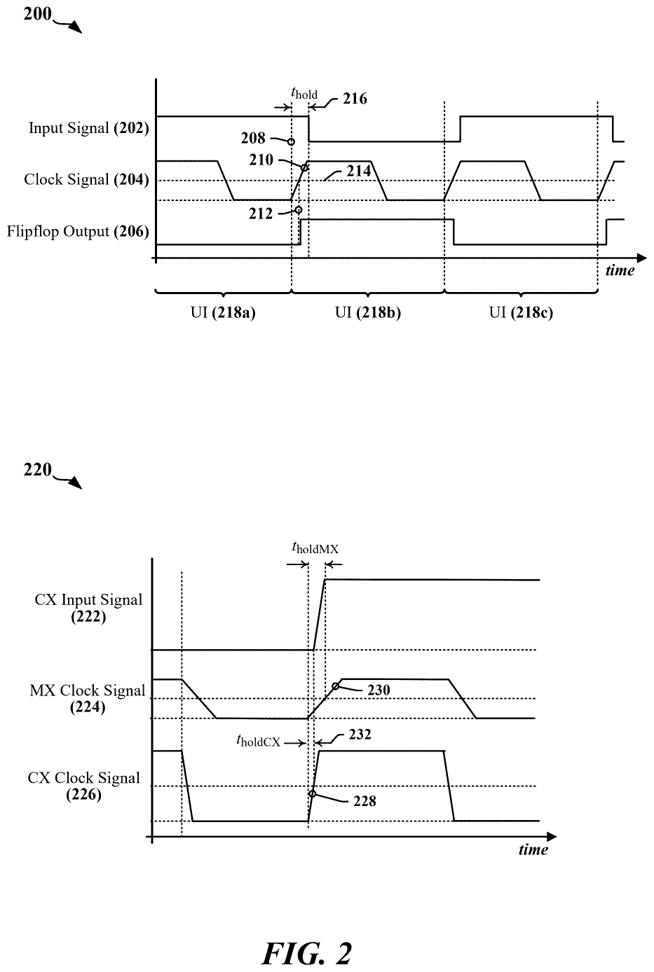

FIG. 2 illustrates certain aspects of timing 200 defined for a sequential logic circuit. For the purposes of this disclosure, a sequential logic circuit refers to a logic circuit that has outputs that are state dependent. For example, certain latches or flipflops have an output that reflects the signaling state of its input when an edge occurs in a clock signal. In some instances, the output of a latch follows its input while the clock signal is in a first signaling state and locks its output when the clock signal transitions from the first signaling state to a second signaling state.

In the illustrated timing 200, the sequential logic circuit receives an input signal 202 that is toggling between higher voltage and lower voltage signaling states in consecutive bit transmission intervals. Bit transmission intervals may be referred to as unit intervals (e.g., UI 218a, UI 218b and UI 218c). The sequential logic circuit is configured to capture the signaling state of the input signal 202 based on timing provided by a clock signal 204. In the illustrated example, the sequential logic circuit provides an output signal 206 that represents the signaling state of the input signal 202 captured at rising edges in the signaling state of the clock signal 204. For the purposes of this disclosure, a rising edge is a transition from a lower voltage signaling state to a higher voltage signaling state.

In the illustrated example, a rising edge 210 in the clock signal 204 commences at a first point in time 208. Latching circuits in the sequential logic circuit may be switched at a second point in time 212 after the signaling state of the clock signal 204 crosses a threshold voltage level 214. In this example, the threshold voltage level 214 is depicted as a voltage level that is substantially halfway between the higher voltage and lower voltage signaling states. In other examples, the threshold voltage level 214 may be closer to the higher voltage signaling state or to the lower voltage signaling state. The input signal 202 is expected to remain constant for a duration of time that is sufficient to enable the signaling state of the clock signal 204 to reach the threshold voltage level 214 such that the signaling state of the input signal 202 is reliably captured. Accordingly, a nominal minimum hold time 216 is typically specified for the input signal 202 to ensure reliable operation of the sequential logic circuit.

If the timing of the input signal 202 does not comply with the nominal minimum hold time 216, then the sequential logic circuit may capture a data bit from the next bit transmission interval. In the illustrated example, the sequential logic circuit captures signaling state from UI 218a in a compliant input signal 202 but may incorrectly capture signaling state from UI 218b when the input signal 202 does not maintain signaling state during the nominal minimum hold time 216.

The hold time after clock signal transitions defined for input signals received by circuits in a core voltage domain is typically dependent on the performance of the circuits in the core voltage domain. However, these inputs may be generated and/or preprocessed in a periphery voltage domain that supplies current at a greater voltage than the core voltage domain. Longer hold times may be required for signals originating in the periphery voltage domain when the periphery voltage domain provides current at a greater voltage than the core voltage domain.

FIG. 2 further illustrates an example of timing 220 in a multi-rail SDRAM device that includes different voltage domains for memory and control logic. The different voltage domains may be required or desired in order to improve performance and optimize power consumption of memory and its associated circuits. In some implementations, memory and peripheral circuits may be provided in different voltage domains to optimize system performance and/or power consumption by enabling certain circuits in a data or clock signal path to avoid voltage constraints imposed on circuits in a different part of the data or clock signal path. In the illustrated example, the a first voltage domain is denoted as the MX domain or simply MX, and a second voltage domain may be referenced as the control domain and/or denoted as the CX domain, or simply CX. In some instances, the transistors and/or circuits in the CX domain generate signals that have faster transitions than signals output by circuits in the MX domain. For example, the rising edge 228 in the clock signal 226 used by CX domain circuits may rise faster than the rising edge 230 in the clock signal 224 used by MX domain circuits. A hold time 232 defined for circuits within the CX domain may be insufficient to ensure proper capture of data bits from an input signal 222 received in the CX domain when the input signal 222 is generated by circuits implemented the MX domain. In some operating modes, periphery circuits may be operated in a CX domain that provides power at a higher voltage than the voltage at which the MX domain supplies power to memory circuits. In other operating modes, the CX domain may provide power at a lower voltage than the voltage at which the MX domain supplies power. In certain operating modes, the CX and MX domains may provide power at substantially the same voltage level.

For data paths that span multiple voltage domains, input hold times are typically defined based on clock signal characteristics in the MX domain. In certain operating modes, significantly increased hold times may be required at interfaces between different voltage domains. In one example, a significantly greater hold time may be required at the interface between a higher-voltage CX domain and a lower voltage MX domain than at the interface between a higher voltage CX domain and a higher-voltage MX domain (e.g., when the CX and MX domains may provide power at substantially the same voltage level).

Large hold times may be required for sequential logic elements operating at the interface between a lower-voltage MX voltage domain in which memory resides and the higher-voltage periphery circuits in a higher-voltage CX voltage domain in which memory support and I/O logic circuits reside. For example, signals generated in the CX domain may be level-shifted to obtain input signals that comply with voltage specifications defined for the MX domain. The timing of these input signals is controlled by circuits in the CX domain and undesirably large hold times may be required to ensure reliable operation of the circuits in the MX domain in conventional systems. Increased minimum hold times may require the use of buffer elements and other devices to delay signal transitions.

The typical word size supported by SDRAM devices is such that hundreds of thousands of buffer elements may need to be added in conventional systems in order to meet the hold times for data and control signals that are transferred between voltage domains. The increased complexity generally consumes a large physical area of a conventional IC device, increases power consumption and leakage and reduces performance. In one example, a memory device that uses multiple power rails may include five hundred thousand or more delay buffers, can experience a timing loss of due to increased hold times and increased power consumption can be attributed to the addition of the delay buffers.

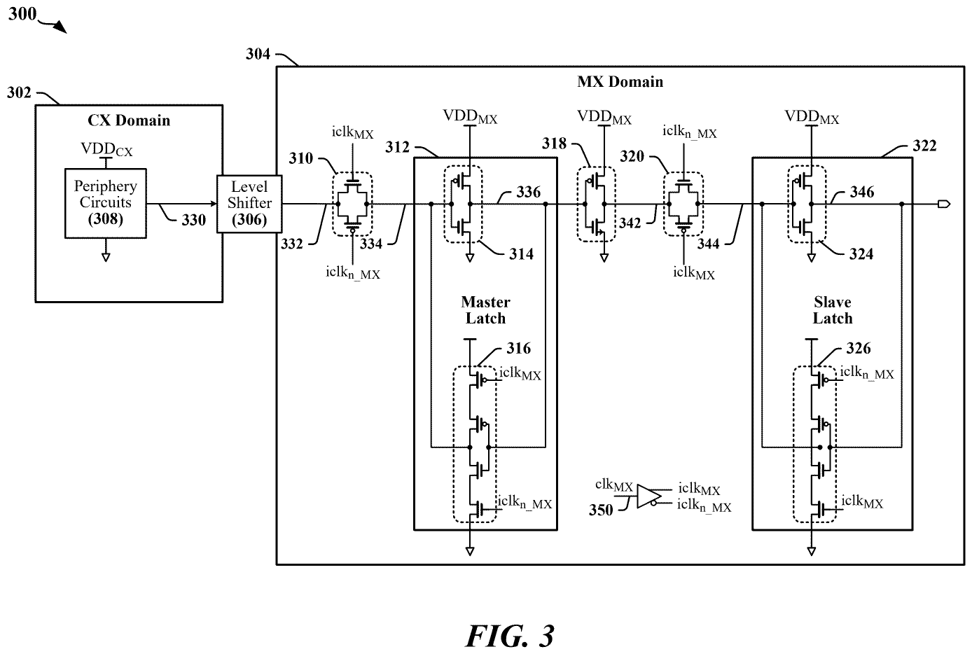

FIG. 3 illustrates an example of an interface 300 between voltage domains in a conventional SDRAM device. Control logic or other periphery circuits 308 in a CX domain 302 generate a signal 330 that is coupled to an input of one or more circuits in a MX domain 304. A level-shifting circuit 306 receives the CX domain signal 330 and provides an input signal 332 that complies with voltage specifications defined for the MX domain 304. The level-shifting circuit 306 provides an input signal 332 that switches between voltage levels defined for signals propagated through, or generated within the MX domain 304. In the illustrated example, the input signal 332 is coupled to the input 334 of a master latch circuit 312 through a pass gate circuit 310 that is controlled by a differential version of a clock signal (clk_{MX} 350). For the purposes of this disclosure, a differential signal comprises a complementary pair of signals that are phase-shifted by 180° with respect to one another. A first signal that is a phase-shifted by 180° with respect to a second signal may be referred to as an inverted version of the second signal. The input signal 332 drives the gates of transistors in a first inverter circuit 314 when the pass gate circuit 310 is enabled. The pass gate circuit 310 is enabled when clk_{MX} 350 is in a first signaling state and disabled when clk_{MX} 350 is in a second signaling state. The gates of the transistors in the first inverter circuit 314 are driven by a first feedback inverter circuit 316 when the pass gate circuit 310 is disabled. The first feedback inverter circuit 316 is controlled by an inverted differential version of clk_{MX} 350 and is enabled when clk_{MX} 350 is in the second signaling state and disabled when clk_{MX} 350 is in the first signaling state. The drains of the transistors in the first inverter circuit 314 are coupled to the gates of the transistors in the first feedback inverter circuit 316, thereby completing a feedback path.

The drains of the transistors in the first inverter circuit 314 are further coupled to an output 336 of the master latch circuit 312, which is coupled to the gates of the transistors in a second inverter circuit 318. An output 342 of the second inverter circuit 318 is coupled to a slave latch circuit 322 through a pass gate circuit 320 that is controlled by the inverted differential version of clk_{MX} 350. The output 342 of the second inverter circuit 318 drives an input 344 of the slave latch circuit 322 when pass gate circuit 320 is enabled. The input 344 of the slave latch circuit 322 is coupled to the gates of transistors in a third inverter circuit 324. Pass gate circuit 320 is enabled when clk_{MX} 350 is in the second signaling state and disabled when clk_{MX} 350 is in the first signaling state. The input 344 of the slave latch circuit 322 is driven by a second feedback inverter circuit 326 when pass gate circuit 320 is disabled. The second feedback inverter circuit 326 is controlled by a non-inverted differential version of clk_{MX} 350 and is enabled when clk_{MX} 350 is in the first signaling state and disabled when clk_{MX} 350 is in the second signaling state. The drains of the transistors in the second inverter circuit 324 are coupled to the gates of the transistors in the second feedback inverter circuit 326, thereby completing a feedback path. The drains of the transistors in the second inverter circuit 324 are further coupled to an output 346 of the slave latch circuit 322.

In some conventional systems, a latching circuit may be added in the CX domain 302 in order to ensure compliance with the nominal minimum hold time defined for the MX domain 304. The addition of such a CX latching circuit can exacerbate certain issues. For example, physical area, power consumption and leakage may be increased and timing can be compromised due to additional half-cycle delays when transmitting certain signals to the MX domain 304. Timing issues may also arise due to increased setup timing. Setup timing may refer to the minimum time a signal is required to be stable prior to a sampling or latching transition in a clock signal.

Certain aspects of this disclosure relate to interface circuits that enable hold time requirements to be dominated by the higher voltage domain. In one example, hold times defined for a higher voltage CX domain can be accommodated by circuits in a lower-voltage MX domain. In another example, hold times defined for a higher voltage MX domain can be accommodated by circuits in a lower-voltage CX domain. In these and other examples, optimized and/or reduced hold times may be achieved and scalable multimode operation can be supported.

Certain aspects of this disclosure are described with reference to an example of a system that includes an enhanced master latch in the MX domain. This example is used solely to facilitate disclosure and the concepts disclosed herein are applicable to other systems and configurations of circuits within a variety of possible voltage domain combinations. The enhanced master latch illustrated in the MX domain enables the design and timing of memory and other circuits to remain unchanged in multimode operation. For example, the design of the level-shifting circuit 306 and slave latch 322 in FIG. 3 can be preserved without change.

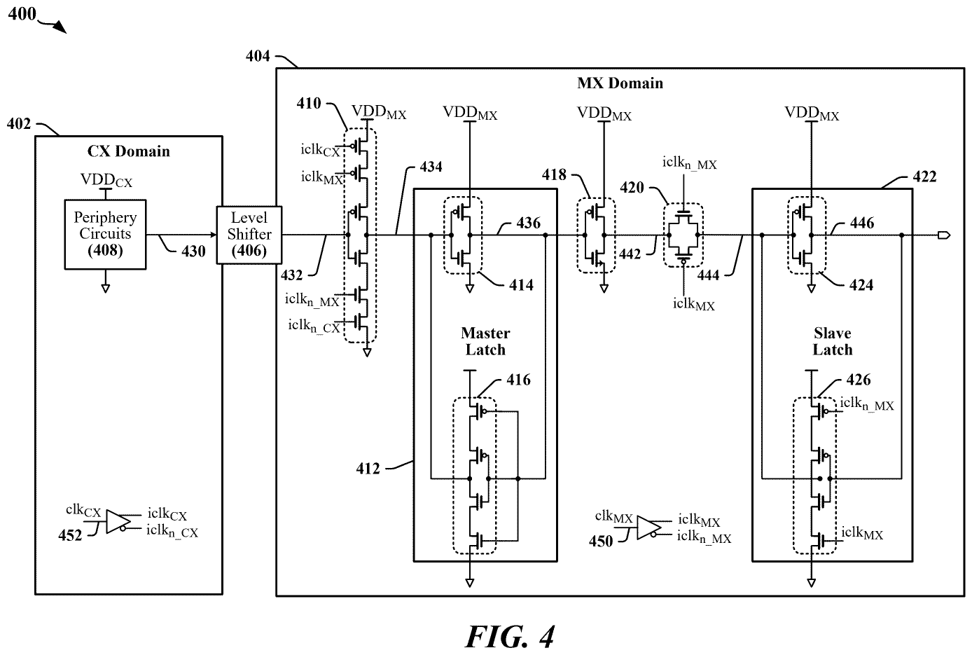

FIG. 4 illustrates a first example of an interface 400 configured in accordance with certain aspects of this disclosure. In one example, the interface 400 can support signal exchange between voltage domains in a SDRAM device. According to one aspect, the input 434 of a master latch circuit 412 located in a MX domain 404 is concurrently controlled by a combination of clock signals configured for a CX domain 402 and clock signals configured for the MX domain 404.

Control logic or other periphery circuits 408 in the CX domain 402 generate a signal 430 to be coupled to an input of one or more circuits in the MX domain 404 through a level-shifting circuit 406. The level-shifting circuit 406 provides an input signal 432 that switches between voltage levels defined for signals propagated through, or generated within the MX domain 404. In the illustrated example, the input signal 432 is coupled to the input 434 of a master latch circuit 412 through a gating inverter circuit 410 that is concurrently controlled by a differential version of a clock signal (clk_{MX} 450) that nominally switches between signaling states specified for the MX domain 404 and a differential version of a clock signal (clk_{CX} 452) that nominally switches between signaling states specified for the CX domain 402. The gating inverter circuit 410 drives the gates of transistors in a first inverter circuit 414 when the gating inverter circuit 410 is enabled.

The gating inverter circuit 410 is enabled when clk_{MX} 450 is in a first signaling state and clk_{CX} 452 is in a third signaling state. The gating inverter circuit 410 is disabled when either clk_{MX} 450 is in a second signaling state or clk_{CX} 452 is in a fourth signaling state. In one example, the first signaling state is defined by a voltage that is greater than the voltage that defines the second signaling state and the third signaling state is defined by a voltage that is greater than the voltage that defines the fourth signaling state. In some instances, the voltage difference between the first signaling state and the second signaling state is greater than the voltage difference between the third signaling state and the fourth signaling state. In some instances, the voltage difference between the third signaling state and the fourth signaling state is greater than the voltage difference between the first signaling state and the second signaling state. Typically, clk_{MX} 450 and clk_{CX} 452 are synchronized and in-phase with respect to one another, such that rising edges in clk_{MX} 450 are initiated at nominally the same point in time that rising edges in clk_{CX} 452 are initiated and such that falling edges in clk_{MX} 450 are initiated at nominally the same point in time that falling edges in clk_{CX} 452 are initiated.

The gates of the transistors in the first inverter circuit 414 are driven by a first feedback inverter circuit 416 when the gating inverter circuit 410 is disabled. The drains of the transistors in the first inverter circuit 414 are coupled to the gates of the transistors in the first feedback inverter circuit 416, thereby completing a feedback path.

The drains of the transistors in the first inverter circuit 414 are further coupled to an output 436 of the master latch circuit 412, which is coupled to the gates of the transistors in a second inverter circuit 418. An output 442 of the second inverter circuit 418 is coupled to a slave latch circuit 422 through a pass gate circuit 420 that is controlled by the inverted differential version of clk_{MX} 450.

The output 442 of the second inverter circuit 418 drives an input 444 of the slave latch circuit 422 when pass gate circuit 420 is enabled. The input 444 of the slave latch circuit 422 is coupled to the gates of transistors in a third inverter circuit 424. Pass gate circuit 420 is enabled when clk_{MX} 450 is in the second signaling state and disabled when clk_{MX} 450 is in the first signaling state. The input 444 of the slave latch circuit 422 is driven by a second feedback inverter circuit 426 when pass gate circuit 420 is disabled. The second feedback inverter circuit 426 is controlled by a non-inverted differential version of clk_{MX} 450 and is enabled when clk_{MX} 450 is in the first signaling state and disabled when clk_{MX} 450 is in the second signaling state. The drains of the transistors in the second inverter circuit 424 are coupled to the gates of the transistors in the second feedback inverter circuit 426, thereby completing a feedback path. The drains of the transistors in the second inverter circuit 424 are further coupled to an output 446 of the slave latch circuit 422.

The master latch circuit 412 in the illustrated example is controlled by a clock signal (clk_{MX} 450) that is configured for the MX domain 404 and a clock signal (clk_{CX} 452) that is configured for the CX domain 402. During the minimum hold time for the specified input signal 432, which begins after edges have been initiated in clk_{MX} 450 and in clk_{CX} 452, the master latch circuit 412 closes. That is to say, the master latch circuit 412 closes when the signaling state of either clkMX 450 or clk_{CX} 452 crosses its respective threshold. In instances where the minimum hold time defined for the MX domain 404 is less than the minimum hold time defined for the CX domain 402, it can be expected that the master latch circuit 412 will be disabled within the minimum hold time defined for the MX domain 404. In instances where the minimum hold time defined for the CX domain 402 is less than the minimum hold time defined for the MX domain 404, it can be expected that the master latch circuit 412 will be disabled within the minimum hold time defined for the CX domain 402 and thereby for the MX domain 404.

In the illustrated example, the slave latch circuit 422 is controlled by clk_{MX} 450 and does not receive clk_{CX} 452. The input to the slave latch circuit 422 is generated within the MX domain 404 and can be expected to comply with the minimum hold time defined for the MX domain 404.

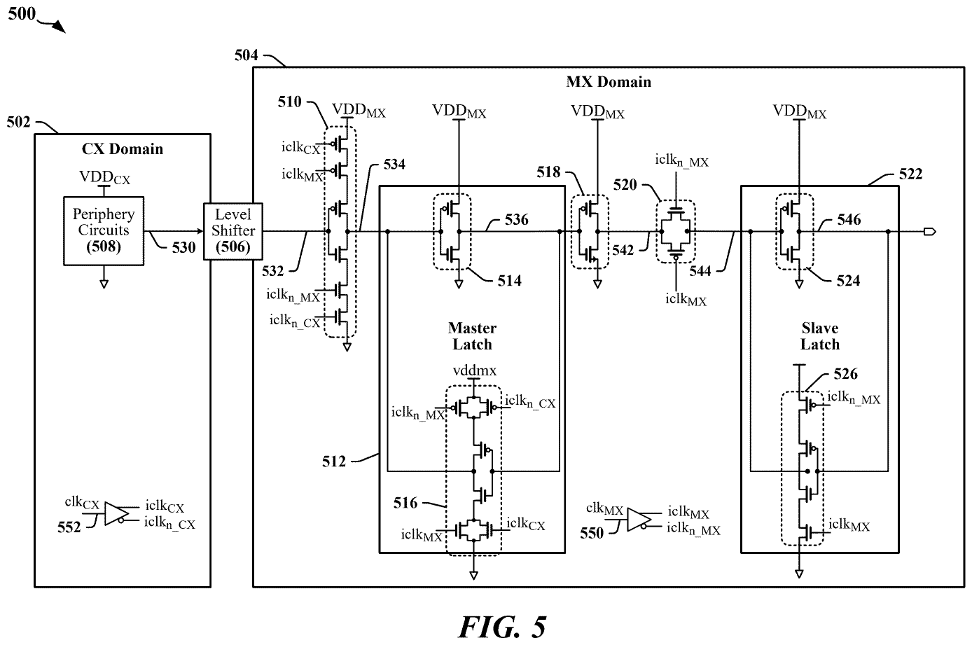

FIG. 5 illustrates a second example of an interface 500 configured in accordance with certain aspects of this disclosure. In one example, the interface 500 can support signal exchange between voltage domains in a SDRAM device. According to one aspect, the input 434 of a master latch circuit 512 located in a MX domain 504 is concurrently controlled by a combination of clock signals configured for a CX domain 502 and clock signals configured for the MX domain 504. According to another aspect, a feedback path in the master latch circuit 512 is concurrently controlled by a different combination of the clock signals configured for a CX domain 502 and clock signals configured for the MX domain 504.

Control logic or other periphery circuits 508 in the CX domain 502 generate a signal 530 to be coupled to an input of one or more circuits in the MX domain 504 through a level-shifting circuit 506. The level-shifting circuit 506 provides an input signal 532 that switches between voltage levels defined for signals propagated through, or generated within the MX domain 504. In the illustrated example, the input signal 532 is coupled to the input 534 of a master latch circuit 512 through a gating inverter circuit 510 that is concurrently controlled by a differential version of a clock signal (clk_{MX} 550) that nominally switches between signaling states specified for the MX domain 504 and a differential version of a clock signal (clk_{CX} 552) that nominally switches between signaling states specified for the CX domain 502. The gating inverter circuit 510 drives the gates of transistors in a first inverter circuit 514 when the gating inverter circuit 510 is enabled.

The gating inverter circuit 510 is enabled when clk_{MX} 550 is in a first signaling state and clk_{CX} 552 is in a third signaling state. The gating inverter circuit 510 is disabled when either clk_{MX} 550 is in a second signaling state or clk_{CX} 552 is in a fourth signaling state. In one example, the first signaling state is defined by a voltage that is greater than the voltage that defines the second signaling state and the third signaling state is defined by a voltage that is greater than the voltage that defines the fourth signaling state. In some instances, the voltage difference between the first signaling state and the second signaling state is greater than the voltage difference between the third signaling state and the fourth signaling state. In some instances, the voltage difference between the third signaling state and the fourth signaling state is greater than the voltage difference between the first signaling state and the second signaling state. Typically, clk_{MX} 550 and clk_{CX} 552 are synchronized and in-phase with respect to one another, such that rising edges in clk_{MX} 550 are initiated at nominally the same point in time that rising edges in clk_{CX} 552 are initiated and such that falling edges in clk_{MX} 550 are initiated at nominally the same point in time that falling edges in clk_{CX} 552 are initiated.

The gates of the transistors in the first inverter circuit 514 are driven by a first feedback inverter circuit 516 when the gating inverter circuit 510 is disabled. The first feedback inverter circuit 516 is controlled by an inverted differential version of clk_{MX} 550 and by an inverted differential version of clk_{CX} 552. The first feedback inverter circuit 516 is enabled when either clk_{MX} 550 is in the second signaling state or clk_{CX} 552 is in the fourth signaling state. The first feedback inverter circuit 516 is disabled when clk_{MX} 550 is in the first signaling state or clk_{CX} 552 is in the third signaling state. The drains of the transistors in the first inverter circuit 514 are coupled to the gates of the transistors in the first feedback inverter circuit 516, thereby completing a feedback path.

The drains of the transistors in the first inverter circuit 514 are further coupled to an output 536 of the master latch circuit 512, which is coupled to the gates of the transistors in a second inverter circuit 518. An output 542 of the second inverter circuit 518 is coupled to a slave latch circuit 522 through a pass gate circuit 520 that is controlled by the inverted differential version of clk_{MX} 550. The output 542 of the second inverter circuit 518 drives an input 544 of the slave latch circuit 522 when pass gate circuit 520 is enabled. The input 544 of the slave latch circuit 322 is coupled to the gates of transistors in a third inverter circuit 524. Pass gate circuit 520 is enabled when clk_{MX} 550 is in the second signaling state and disabled when clk_{MX} 550 is in the first signaling state. The input 544 of the slave latch circuit 522 is driven by a second feedback inverter circuit 526 when pass gate circuit 520 is disabled. The second feedback inverter circuit 526 is controlled by a non-inverted differential version of clk_{MX} 550 and is enabled when clk_{MX} 550 is in the first signaling state and disabled when clk_{MX} 550 is in the second signaling state. The drains of the transistors in the second inverter circuit 524 are coupled to the gates of the transistors in the second feedback inverter circuit 526, thereby completing a feedback path. The drains of the transistors in the second inverter circuit 524 are further coupled to an output 546 of the slave latch circuit 522.

The master latch circuit 512 in the illustrated example is controlled by a clock signal (clk_{MX} 550) that is configured for the MX domain 504 and a clock signal (clk_{CX} 552) that is configured for the CX domain 502. During the minimum hold time for the specified input signal 532, which begins after edges have been initiated in clk_{MX} 550 and in clk_{CX} 552, the master latch circuit 512 closes. That is to say, the master latch circuit 412 closes when the signaling state of either clkMX 550 or clk_{CX} 552 crosses its respective threshold. In instances where the minimum hold time defined for the MX domain 504 is less than the minimum hold time defined for the CX domain 502, it can be expected that the master latch circuit 512 will be disabled within the minimum hold time defined for the MX domain 504. In instances where the minimum hold time defined for the CX domain 502 is less than the minimum hold time defined for the MX domain 504, it can be expected that the master latch circuit 512 will be disabled within the minimum hold time defined for the CX domain 502 and thereby for the MX domain 504.

In the illustrated example, the slave latch circuit 522 is controlled by clk_{MX} 550 and does not receive clk_{CX} 552. The input to the slave latch circuit 522 is generated within the MX domain 504 and can be expected to comply with the minimum hold time defined for the MX domain 504.

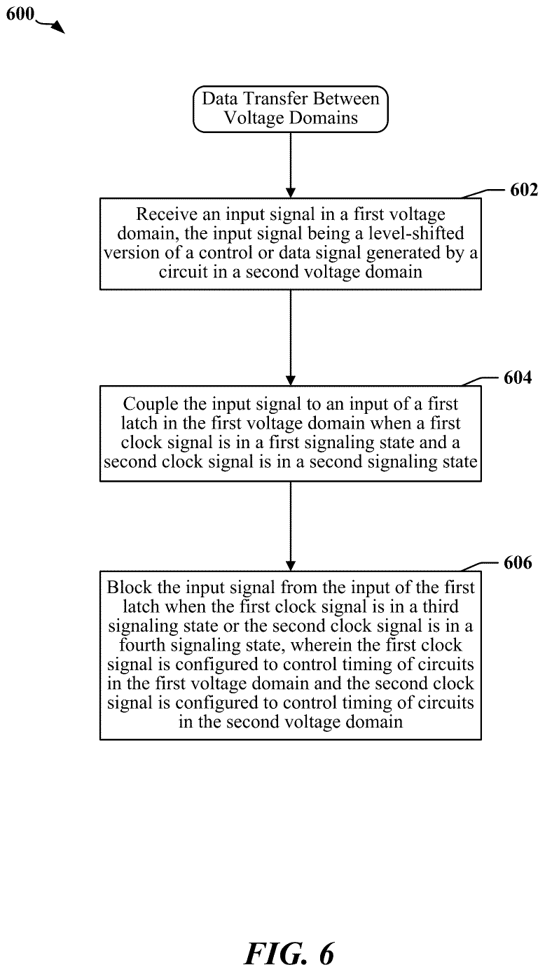

FIG. 6 is a flow diagram illustrating an example of a method 600 for transferring data between voltage domains. The method may be performed at or near a physical interface between circuits that are coupled to different power rails that supply power at different voltage levels. In certain implementations, the method 600 may be performed using circuits involved in data capture in one voltage domain from signals that originate in a different voltage domain. For example, the method 600 may be performed at the master latch circuit 512 illustrated in FIG. 5 or the master latch circuit 412 illustrated in FIG. 4.

At block 602, an input signal is received by a circuit provided within a first voltage domain. The input signal may be a level-shifted version of a control or data signal generated by a circuit in a second voltage domain. The input signal may be level-shifted using a level shifting circuit. In one example, a level shifting circuit includes a stack of low-voltage transistors coupled between power rails that have a voltage difference greater than the nominal maximum voltage level defined for the low-voltage transistors. The gate inputs of the stack of low-voltage transistors may be configured to ensure that voltage drops are shared by all of the transistors in the stack of low-voltage transistors. In some instances, a combination of low-voltage transistors and transistors rated for higher voltage levels may be stacked.

At block 604, the input signal may be coupled to an input of a first latch in the first voltage domain when a first clock signal is in a first signaling state and a second clock signal is in a second signaling state. At block 606, the input signal may be blocked or gated from the input of the first latch when the first clock signal is in a third signaling state or the second clock signal is in a fourth signaling state. The first clock signal may be configured to control timing of circuits in the first voltage domain. The second clock signal may be configured to control timing of circuits in the second voltage domain.

In some implementations, the first clock signal is a level-shifted, in-phase version of the second clock signal. The polarity of the first signaling state with respect to the third signaling state corresponds to the polarity of the second signaling state with respect to the fourth signaling state. The first signaling state and the third signaling state may each represent a first logic value or state and the second signaling state and the fourth signaling state may each represent a second logic value or state that is different from the first logic value or state.

In some implementations, a feedback signal representative of an output of the first latch is provided to the input of the first latch when the gating circuit is disabled. The feedback signal may be provided by a feedback circuit that is enabled when the gating circuit is disabled. The feedback circuit may be configured to drive the input of the first latch when the feedback circuit is enabled. In one example, feedback circuit may be configured to drive the input of the first latch when the first clock signal is in the third signaling state or the second clock signal is in the fourth signaling state.

In some implementations, an output of the first latch is provided to an input of a second latch in the first voltage domain. The second latch may be controlled by the first clock signal. The second latch may operate independently of the second clock signal. In one example, the second latch can operate independently of the second clock signal when its inputs and outputs are coupled solely to circuits provided in the first voltage domain.

The operational steps described in any of the exemplary aspects herein are described to provide examples. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flow diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various operations of methods described above may be performed by any suitable means capable of performing the corresponding functions. The means may include various hardware and/or software component(s) and/or module(s), including, but not limited to a circuit, an application-specific integrated circuit (ASIC), or processor. Generally, where there are operations illustrated in figures, those operations may have corresponding counterpart means-plus-function components with similar numbering. In certain aspects, an apparatus includes means for gating an input signal in a first voltage domain and means for capturing signaling state of the input signal in the first voltage domain. The input signal may be a level-shifted version of a control or data signal generated by a circuit in a second voltage domain. The means for capturing signaling state of the input signal in the first voltage domain may be implemented using one or more sequential logic circuits. In one example, the means for capturing signaling state of the input signal includes a first latch that is controlled by a first clock signal and a second clock signal. The means for gating the input signal may be configured to couple the input signal to an input of the first latch when the first clock signal is in a first signaling state and the second clock signal is in a second signaling state. The first clock signal may be configured to control timing of circuits in the first voltage domain and the second clock signal may be configured to control timing of circuits in the second voltage domain.

In some implementations, the first clock signal is a level-shifted, in-phase version of the second clock signal. In one example, the first clock signal is derived from the second clock signal. In another example, the second clock signal is derived from the first clock signal. In another example, the first clock signal and the second clock signal are versions of a root or master clock signal.

In some implementations, the input signal may be level-shifted using a level shifting circuit. In one example, a level shifting circuit includes a stack of low-voltage transistors coupled between power rails that have a voltage difference greater than the nominal maximum voltage level defined for the low-voltage transistors. The gate inputs of the stack of low-voltage transistors may be configured to ensure that voltage drops are shared by all of the transistors in the stack of low-voltage transistors. In some instances, a combination of low-voltage transistors and transistors rated for higher voltage levels may be stacked.

In certain implementations, a feedback signal representative of an output of the first latch is coupled to the input of the first latch when the gating circuit is disabled. The feedback signal may be provided by a feedback circuit that is enabled when the gating circuit is disabled. The feedback circuit may be configured to drive the input of the first latch when the feedback circuit is enabled. In one example, feedback circuit may be configured to drive the input of the first latch when the first clock signal is in the third signaling state or the second clock signal is in the fourth signaling state.

In some implementations, the means for capturing the signaling state of the input signal includes a second latch. The second latch may be provided in the first voltage domain. The second latch may be controlled by the first clock signal and may have an input that is coupled to an output of the first latch. The second latch may operate independently of the second clock signal. In one example, the second latch can operate independently of the second clock signal when its inputs and outputs are coupled solely to circuits provided in the first voltage domain.

According to certain aspects of this disclosure, a data capture circuit may be implemented with one or more latches and a gating circuit. A first latch may be provided in a first voltage domain. The first latch may include a feedback circuit. The gating circuit may also be provided in the first voltage domain. The gating circuit may be implemented as a gating inverter. The gating circuit may be configured to couple an input signal to an input of the first latch when a first clock signal is in a first signaling state and a second clock signal is in a second signaling state. The gating circuit may be disabled when the first clock signal is in a third signaling state or the second clock signal is in a fourth signaling state. The first clock signal may be configured to control timing of circuits in the first voltage domain and the second clock signal may be configured to control timing of circuits in a second voltage domain. The gating circuit may be controlled by a differential version of the first clock signal and a differential version of the second clock signal.

In some implementations, the first clock signal is a level-shifted, in-phase version of the second clock signal. The input signal may be representative of a control or data signal generated by a circuit in the second voltage domain. The input signal may be a level-shifted version of the control or data signal generated by the circuit in the second voltage domain.

In some implementations, the first latch includes a feedback circuit having an input coupled to an output of the first latch and configured to drive the input of the first latch when the gating circuit is disabled. The feedback circuit may be configured to drive the input of the first latch when the first clock signal is in the third signaling state or the second clock signal is in the fourth signaling state.

In some implementations, a second latch provided in the first voltage domain has an input coupled to an output of the first latch and the operation of the second latch is controlled by the first clock signal. The feedback signal may be provided by a feedback circuit that is enabled when the gating circuit is disabled. The feedback circuit may be configured to drive the input of the first latch when the feedback circuit is enabled. In one example, feedback circuit may be configured to drive the input of the first latch when the first clock signal is in the third signaling state or the second clock signal is in the fourth signaling state.

Some implementation examples are described in the following numbered clauses:
1. A data capture circuit comprising: a first latch provided in a first voltage domain; and a gating circuit provided in the first voltage domain and configured to couple an input signal to an input of the first latch when a first clock signal is in a first signaling state and a second clock signal is in a second signaling state, wherein the gating circuit is disabled when the first clock signal is in a third signaling state or the second clock signal is in a fourth signaling state, and wherein the first clock signal is configured to control timing of circuits in the first voltage domain and the second clock signal is configured to control timing of circuits in a second voltage domain.
2. The data capture circuit as described in clause 1, wherein the first clock signal is a level-shifted, in-phase version of the second clock signal.
3. The data capture circuit as described in clause 1 or clause 2, wherein the first latch includes: a feedback circuit having an input coupled to an output of the first latch and configured to drive the input of the first latch when the gating circuit is disabled.
4. The data capture circuit as described in any of clauses 1-3, further comprising: a feedback circuit having an input coupled to an output of the first latch and configured to drive the input of the first latch when the first clock signal is in the third signaling state or the second clock signal is in the fourth signaling state.
5. The data capture circuit as described in any of clauses 1-4, wherein the gating circuit comprises: a gating inverter that is controlled by a differential version of the first clock signal and a differential version of the second clock signal.
6. The data capture circuit as described in any of clauses 1-5, wherein the input signal is representative of a control or data signal generated by a circuit in the second voltage domain.
7. The data capture circuit as described in clause 6, wherein the input signal is a level-shifted version of the control or data signal generated by the circuit in the second voltage domain.
8. The data capture circuit as described in any of clauses 1-7, further comprising: a second latch provided in the first voltage domain, the second latch having an input coupled to an output of the first latch.
9. The data capture circuit as described in clause 8, wherein operation of the second latch is controlled by the first clock signal.
10. An apparatus comprising: means for gating an input signal in a first voltage domain, the input signal being a level-shifted version of a control or data signal generated by a circuit in a second voltage domain; and means for capturing signaling state of the input signal in the first voltage domain, including a first latch that is controlled by a first clock signal and a second clock signal, wherein the means for gating the input signal is configured to couple the input signal to an input of the first latch when the first clock signal is in a first signaling state and the second clock signal is in a second signaling state, and wherein the first clock signal is configured to control timing of circuits in the first voltage domain and the second clock signal is configured to control timing of circuits in the second voltage domain.
11. The apparatus as described in clause 10, wherein the first clock signal is a level-shifted, in-phase version of the second clock signal.
12. The apparatus as described in clause 10 or clause 11, wherein a feedback signal representative of an output of the first latch is coupled to the input of the first latch when the gating circuit is disabled.
13. The apparatus as described in clause 12, further comprising: means for providing the feedback signal, wherein the means for providing the feedback signal is disabled when the first clock signal is in the first signaling state and the second clock signal is in the second signaling state.
14. The apparatus as described in any of clauses 10-13, wherein the means for capturing the signaling state of the input signal comprises: a second latch in the first voltage domain that is controlled by the first clock signal and has an input that is coupled to an output of the first latch, wherein the second latch operates independently of the second clock signal.
15. A method for transferring data between voltage domains, comprising: receiving an input signal in a first voltage domain, the input signal being a level-shifted version of a control or data signal generated by a circuit in a second voltage domain; coupling the input signal to an input of a first latch in the first voltage domain when a first clock signal is in a first signaling state and a second clock signal is in a second signaling state; and blocking the input signal from the input of the first latch when the first clock signal is in a third signaling state or the second clock signal is in a fourth signaling state, wherein the first clock signal is configured to control timing of circuits in the first voltage domain and the second clock signal is configured to control timing of circuits in the second voltage domain.
16. The method as described in clause 15, wherein the first clock signal is a level-shifted, in-phase version of the second clock signal.
17. The method as described in clause 15 or clause 16, further comprising: providing a feedback signal representative of an output of the first latch to the input of the first latch when the gating circuit is disabled.
18. The method as described in any of clauses 15-17, further comprising: providing a feedback signal representative of an output of the first latch to the input of the first latch when the first clock signal is in the third signaling state or the second clock signal is in the fourth signaling state.
19. The method as described in any of clauses 15-18, further comprising: providing an output of the first latch to an input of a second latch in the first voltage domain that is controlled by the first clock signal.
20. The method as described in clause 19, wherein the second latch operates independently of the second clock signa.

The present disclosure is provided to enable any person skilled in the art to make or use aspects of the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A data capture circuit, comprising:
a first latch provided in a first voltage domain; and
a gating circuit provided in the first voltage domain and configured to couple an input signal to an input of the first latch when a first clock signal is in a first signaling state and a second clock signal is in a second signaling state,
wherein the gating circuit is disabled when the first clock signal is in a third signaling state or the second clock signal is in a fourth signaling state, and
wherein the first clock signal is configured to control timing of circuits in the first voltage domain and the second clock signal is configured to control timing of circuits in a second voltage domain.

2. The data capture circuit of claim 1, wherein the first clock signal is a level-shifted, in-phase version of the second clock signal.

3. The data capture circuit of claim 1, wherein the first latch includes:
a feedback circuit having an input coupled to an output of the first latch and configured to drive the input of the first latch when the gating circuit is disabled.

4. The data capture circuit of claim 1, further comprising:
a feedback circuit having an input coupled to an output of the first latch and configured to drive the input of the first latch when the first clock signal is in the third signaling state or the second clock signal is in the fourth signaling state.

5. The data capture circuit of claim 1, wherein the gating circuit comprises:
a gating inverter that is controlled by a differential version of the first clock signal and a differential version of the second clock signal.

6. The data capture circuit of claim 1, wherein the input signal is representative of a control or data signal generated by a circuit in the second voltage domain.

7. The data capture circuit of claim 6, wherein the input signal is a level-shifted version of the control or data signal generated by the circuit in the second voltage domain.

8. The data capture circuit of claim 1, further comprising:
a second latch provided in the first voltage domain, the second latch having an input coupled to an output of the first latch.

9. The data capture circuit of claim 8, wherein operation of the second latch is controlled by the first clock signal.

10. An apparatus comprising:
means for gating an input signal in a first voltage domain, the input signal being a level-shifted version of a control or data signal generated by a circuit in a second voltage domain; and
means for capturing signaling state of the input signal in the first voltage domain, including a first latch that is controlled by a first clock signal and a second clock signal,
wherein the means for gating the input signal is configured to couple the input signal to an input of the first latch when the first clock signal is in a first signaling state and the second clock signal is in a second signaling state, and
wherein the first clock signal is configured to control timing of circuits in the first voltage domain and the second clock signal is configured to control timing of circuits in the second voltage domain.

11. The apparatus of claim 10, wherein the first clock signal is a level-shifted, in-phase version of the second clock signal.

12. The apparatus of claim 10, wherein a feedback signal representative of an output of the first latch is coupled to the input of the first latch when the means for gating the input signal is disabled.

13. The apparatus of claim 12, further comprising:
means for providing the feedback signal, wherein the means for providing the feedback signal is disabled when the first clock signal is in the first signaling state and the second clock signal is in the second signaling state.

14. The apparatus of claim 10, wherein the means for capturing the signaling state of the input signal comprises:
a second latch in the first voltage domain that is controlled by the first clock signal and has an input that is coupled to an output of the first latch, wherein the second latch operates independently of the second clock signal.

15. A method for transferring data between voltage domains, comprising:
receiving an input signal in a first voltage domain, the input signal being a level-shifted version of a control or data signal generated by a circuit in a second voltage domain;
coupling the input signal to an input of a first latch in the first voltage domain when a first clock signal is in a first signaling state and a second clock signal is in a second signaling state; and
blocking the input signal from the input of the first latch when the first clock signal is in a third signaling state or the second clock signal is in a fourth signaling state, wherein the first clock signal is configured to control timing of circuits in the first voltage domain and the second clock signal is configured to control timing of circuits in the second voltage domain.

16. The method of claim 15, wherein the first clock signal is a level-shifted, in-phase version of the second clock signal.

17. The method of claim 15, further comprising:
providing a feedback signal representative of an output of the first latch to the input of the first latch when the input signal is blocked.

18. The method of claim 15, further comprising:
providing a feedback signal representative of an output of the first latch to the input of the first latch when the first clock signal is in the third signaling state or the second clock signal is in the fourth signaling state.

19. The method of claim 15, further comprising:
providing an output of the first latch to an input of a second latch in the first voltage domain that is controlled by the first clock signal.

20. The method of claim 19, wherein the second latch operates independently of the second clock signal.
